(19) United States
(12) Patent Application Publication
(10) Pub. No.: US 2024/0379969 A1
(43) Pub. Date: Nov. 14, 2024

(54) CURRENT COLLECTOR, ELECTRODE FOR ELECTRIC STORAGE DEVICE, AND LITHIUM-ION SECONDARY BATTERY

(71) Applicant: TDK Corporation, Tokyo (JP)

(72) Inventors: Ryo SASAKI, Tokyo (JP); Makoto ENDO, Tokyo (JP); Mignyu CHEN, Tokyo (JP); Yoshihiro KANBAYASHI, Tokyo (JP); Takasi SATOU, Tokyo (JP); Natsumi KOZAI, Tokyo (JP); Yoshihiko TANABE, Tokyo (JP); Syuji TSUKAMOTO, Tokyo (JP); Miyuki YANAGIDA, Tokyo (JP); Kosuke TANAKA, Tokyo (JP); Shun IKENARI, Tokyo (JP)

(73) Assignee: TDK Corporation, Tokyo (JP)

(21) Appl. No.: 18/696,750

(22) PCT Filed: Sep. 30, 2021
(86) PCT No.: PCT/JP2021/036089

§ 371 Date: Mar. 28, 2024

(51) Int. Cl. H01M 4/66; H01M 4/13; H01M 10/0525; H01M 10/42

(52) U.S. Cl. CPC H01M 4/667; H01M 4/13; H01M 4/661; H01M 4/662; H01M 4/663; H01M 10/0525; H01M 10/4235

(57) ABSTRACT

A current collector includes a resin layer, a conductive layer, a first intermediate layer that is positioned between the resin layer and the conductive layer and a second intermediate layer that is positioned between the first intermediate layer and the resin layer, the first intermediate layer includes a metal as a main component, and the second intermediate layer includes a metal oxide as a main component.

### TECHNICAL FIELD

The present disclosure relates to a current collector, an electrode for an electric storage device, and a lithium-ion secondary battery.

### BACKGROUND ART

As a current collector for secondary batteries, a composite material having a conductive layer(s) formed on one surface or both surfaces of a resin film has been proposed. Patent Literature 1 discloses a current collector for a secondary battery in which such a composite material is applied to the current collector.

### CITATION LIST

### Patent Literature

[Patent Literature 1] Japanese Unexamined Patent Publication No. 2019-102429

### SUMMARY OF INVENTION

### Technical Problem

In electric storage devices including a non-aqueous electrolytic solution such as a lithium-ion secondary battery, it is known that current collectors deteriorate due to a decomposition product of the non-aqueous electrolytic solution. Even in the case of using the above-described current collector of the composite material in an electric storage device including a non-aqueous electrolytic solution such as a lithium-ion secondary battery, it is preferable to consider the influence of a decomposition product of the non-aqueous electrolytic solution. One embodiment of the present disclosure is to provide a current collector, an electrode for an electric storage device and a lithium-ion secondary battery in which deterioration due to a decomposition product of an electrolyte is suppressed.

### Solution to Problem

A current collector according to one embodiment of the present disclosure includes a resin layer, a conductive layer, a first intermediate layer that is positioned between the resin layer and the conductive layer and a second intermediate layer that is positioned between the first intermediate layer and the resin layer, the first intermediate layer includes a metal as a main component, and the second intermediate layer includes a metal oxide as a main component.

### Advantageous Effects of Invention

According to one embodiment of the present disclosure, a current collector deterioration of which due to a decomposition product of an electrolyte is suppressed is provided.

### BRIEF DESCRIPTION OF DRAWINGS

FIG. 1 is a schematic cross-sectional view showing one example of a current collector of a first embodiment.

FIG. 2 is a view showing an example of the relationship between the surface energies of metals in a foundation layer and a (111) plane orientation index of a Cu layer formed on the foundation layer.

FIG. 3 is a schematic cross-sectional view showing one example of a current collector of a second embodiment.

FIG. 4 is a schematic cross-sectional view showing another example of the current collector of the second embodiment.

FIG. 5 is a schematic exploded perspective view showing one example of an electrode for an electric storage device of a third embodiment.

FIG. 6 is a schematic partially cut perspective view showing one example of a lithium-ion secondary battery of a fourth embodiment.

FIG. 7 is a schematic exploded perspective view showing one example of a cell in the lithium-ion secondary battery shown in FIG. 6.

### DESCRIPTION OF EMBODIMENTS

A current collector including a conductive layer formed on a resin film is different from metal foils that have been conventionally used as a current collector in a single unit form in terms of the structure and the thickness. Particularly, it is different from conventional current collectors in that the current collector is a complex of the resin film and the conductive layer and the conductive layer is thinner than metal foils that are used in conventional current collectors.

A lithium-ion secondary battery usually includes an anion including a fluorine atom as an electrolyte. In a case where such a lithium-ion secondary battery is charged and discharged in a high-temperature environment, the anion including a fluorine atom decomposes, and a fluorine ion, that is, hydrofluoric acid, is generated as a decomposition product. The inventors of the present application obtained an idea of a current collector, an electrode for an electric storage device, and a lithium-ion secondary battery the charge/discharge characteristics of which can be maintained by suppressing deterioration of a current collector having a conductive layer formed on a resin film due to a decomposition product of a non-aqueous electrolytic solution, specifically, suppressing at least one of the dissolution or loss of the conductive layer and the peeling of the conductive layer from the resin film.

Hereinafter, embodiments of a current collector, an electrode for an electric storage device, and a lithium-ion secondary battery of the present disclosure will be described with reference to drawings. Numerical values, shapes, materials, steps, the order of the steps and the like to be proposed in the following description are simply examples, and a variety of modifications are possible as long as no technical contradictions are caused. In addition, each of the embodiments to be described below is simply an example, and a variety of combinations are possible as long as no technical contradictions are caused.

There will be cases where the thicknesses, dimensions, shapes and the like of members shown in the drawings of the present disclosure are exaggerated for the convenience of description. In addition, in the drawings of the present disclosure, there will be cases where only some of members are shown or some of elements are not shown to avoid excessive complexity. Therefore, there will be cases where each dimension of a member and the disposition between members shown in the drawings of the present disclosure do not reflect each dimension of the member and the disposition between the members in an actual device. “Being perpendicular” and “being orthogonal” in the present disclosure are not limited to cases where two straight lines, sides, surfaces and the like strictly form an angle of 90°, and include cases where the angle is within a range of approximately 90°±5°. In addition, “being parallel” includes cases where two straight lines, sides, surfaces and the like are within a range of approximately 0°±5°.

In the present specification, the term “cell” refers to a structure in which at least a pair of a positive electrode and a negative electrode are integrally assembled. The term “battery” in the present specification is used as a term that comprehensively includes a variety of forms such as a battery module and a battery pack having one or more “cells” electrically connected to each other.

### First Embodiment

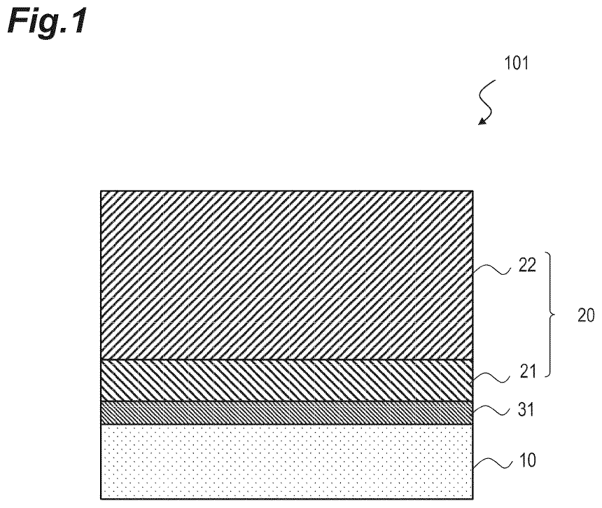

FIG. 1 is a schematic cross-sectional view showing one example of a current collector of the present embodiment. The current collector of the present embodiment can also be used as a current collector for any electrode of a positive electrode and a negative electrode of an electric storage device such as a lithium-ion secondary battery. A current collector 101 includes a resin layer 10, a conductive layer 20 and a first intermediate layer 31 that is positioned between the resin layer and the conductive layer 20.

The resin layer 10 functions as a support of the conductive layer 20 in the current collector 101. In addition, the resin layer 10 has a smaller density than the conductive layer 20 and is thereby capable of contributing to an increase in the charge capacity per unit weight in the case of configuring an electric storage device.

The resin layer 10 has an electrically insulating property and includes a resin. The resin layer 10 may have a thermoplastic property. Specifically, the resin layer 10 may include at least any one of polyethylene terephthalate (PET), polypropylene (PP), polyamide (PA), polyimide (PI), polyethylene (PE), polystyrene (PS), a phenolic resin (PF) and an epoxy resin (EP). The resin layer 10 may be a single layer or may be configured by stacking a plurality (two or more) of layers. In this case, at least one layer of the plurality of layers may include a different resin.

The thickness of the resin layer 10 is, for example, 3 μm or more and 12 μm or less. The thickness of the resin layer 10 may be 3 μm or more and 6 μm or less. When the thickness of the resin layer 10 is 3 μm or more, a sufficient strength as a support can be obtained. In addition, when the thickness of the resin layer 10 is 12 μm or less, it is possible to decrease the thickness of the entire current collector 101. Therefore, in the case of configuring a stacked lithium-ion secondary battery by stacking a plurality of electrode pairs, it is possible to decrease the proportion of a portion that does not contribute to storage of energy and to increase the energy density. When the thickness of the resin layer 10 is 6 μm or less, it is possible to further decrease the thickness of the entire current collector 101 and to increase the energy density of the stacked lithium-ion secondary battery.

The current collector 101 may further include an undercoat layer that is positioned between the resin layer 10 and the first intermediate layer 31. The undercoat layer can be provided to increase the joint strength between the resin layer 10 and the first intermediate layer 31 or suppress the formation of a pinhole in the first intermediate layer 31. For example, the undercoat layer may be a layer formed of an organic material such as an acrylic resin or a polyolefin resin or a metal-including layer formed by sputtering.

The first intermediate layer 31 controls the crystal orientation of the conductive layer 20. Specifically, the first intermediate layer 31 controls the crystal orientation of the conductive layer 20 so that the conductive layer 20 that is formed on the first intermediate layer 31 has a denser crystal structure. The first intermediate layer 31 includes a metal as a main component, and the surface energy of the metal that is included in the first intermediate layer 31 is larger than the surface energy of a metal that is included in the conductive layer 20 as a main component. As described below in detail, when this relationship is satisfied, the conductive layer 20 is likely to be (111)-oriented. The main component refers to a component having the largest content percentage expressed in mole percent in a case where a member includes one or a plurality of components.

A thickness D1 of the first intermediate layer 31 is, for example, 1 nm or more and 120 nm or less. When the thickness DI of the first intermediate layer 31 is 1 nm or more, it is possible to form a continuous film, and it becomes easy to control the orientation of the entire conductive layer 20 to be formed. When the thickness D1 of the first intermediate layer 31 is 120 nm or less, the time necessary to form the first intermediate layer 31 does not become too long, the influence of damage attributed to conditions during the formation of the first intermediate layer 31, for example, heat or plasma on the resin layer 10 becomes small, and deterioration of the resin layer 10 can be suppressed. The thickness of the first intermediate layer 31 may be 2 nm or more and 100 nm or less.

The first intermediate layer 31 may include, for example, at least one metal selected from the group consisting of Ni, Cr, Co, Ti, Zr, Nb, Hf, Ta and W. Among these metals, it is possible to select a metal that satisfies the above-described relationship in terms of the surface energy with the metal in the conductive layer 20. In a case where the conductive layer 20 is composed of Cu, the first intermediate layer 31 can be made of, for example, Ni, Cr, a Ni—Cr alloy, Co or W. In a case where the conductive layer 20 is composed of Al, the first intermediate layer 31 can be made of, for example, Ni or Cr. The first intermediate layer 31 can be formed using a well-known thin film formation technique that is used for the manufacturing of semiconductor devices such as a vacuum vapor deposition method or a sputtering method.

The conductive layer 20 is a main current path in the current collector 101 and exchanges electrons with terminals or the like that are connected to a positive electrode active material or a negative electrode active material and the current collector. The conductive layer 20 includes a metal as a main component and has a (111) orientation due to the action of the first intermediate layer 31. The conductive layer 20 may be in contact with the first intermediate layer 31 from the viewpoint of having the (111) orientation.

Usually, the (111) plane of a metal layer has a large surface atom density compared with (100), (110) or the like and is thus excellent in terms of corrosion resistance. Therefore, the conductive layer 20 has high corrosion resistance to a decomposition product of an electrolyte in non-aqueous electrolytic solutions in lithium-ion secondary batteries and the like.

In the conductive layer 20, the orientation of the (111) plane may be high. Specifically, it is possible to set the orientation index of the (111) plane of the conductive layer 20 by the Lotgering method in a direction perpendicular to the resin layer 10 to 0.3 or more. The orientation index can be set to, for example, 0.7 or more. The orientation index will be described below in detail.

The thickness of the conductive layer 20 is, for example, 0.3 μm or more and 2 μm or less. When the thickness of the conductive layer 20 is 0.3 μm or more, it is possible to decrease the resistance of the conductive layer 20. For example, it is possible to decrease an energy loss attributed to a resistance in the current collector in a case where an electric storage device has been produced. In addition, when the thickness of the conductive layer 20 is 2 μm or less, the ratio of the conductive layer 20 to the resin layer 10 becomes relatively small, and it becomes easy to obtain a merit of reducing the weight of the current collector using the resin layer 10. The thickness of the conductive layer 20 may be 0.5 μm or more and 1.2 μm or less.

The conductive layer 20 may include, for example, one metal selected from the group consisting of Al, Ag, Cu, Ni and a Ni—Cu alloy. In a case where the current collector 101 is used in a positive electrode, the conductive layer 20 may include Al. In a case where the current collector 101 is used in a negative electrode, the conductive layer 20 may include one metal selected from the group consisting of Ag, Cu, Ni and a Ni—Cu alloy.

In the present embodiment, the conductive layer 20 includes a seed layer 21 and a main layer 22. The seed layer 21 and the main layer 22 each include a metal as a main component and may be composed of the same metal.

The seed layer 21 is formed by, for example, a sputtering method or a vacuum vapor deposition method, and the main layer 22 is formed by a plating method. This is to avoid a long formation time and the consequent deterioration of productivity and an increase in damage to the resin layer 10 during the formation of the conductive layer 20 in a case where the conductive layer 20 is relatively thick and the entire conductive layer 20 is formed by a sputtering method or a vacuum vapor deposition method. Here, the conductive layer 20 may not include the seed layer 21. For example, the first intermediate layer 31 may be used as a conductive layer for performing plating.

In a case where the conductive layer 20 includes the seed layer 21 and the main layer 22, the seed layer 21 that is in contact with the first intermediate layer 31 has a (111) orientation due to the action of the first intermediate layer 31. The main layer 22 has a (111) orientation in accordance with the orientation of the seed layer 21.

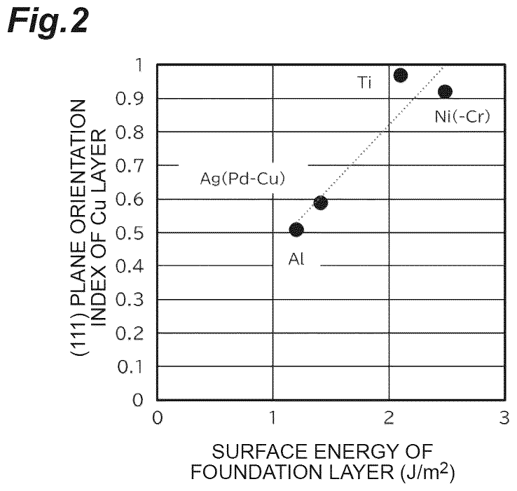

Next, the control of the orientation of the conductive layer 20 with the first intermediate layer 31 will be described. As described above, the use of a conductive layer in which the orientation of a (111) plane, which is a dense orientation plane, is high in a current collector is considered to suppress corrosion caused by a decomposition product of an electrolyte that is included in a non-aqueous electrolytic solution. The inventors of the present application formed a foundation layer composed of a variety of metals and investigated the orientation of a Cu layer that was formed on the foundation layer. FIG. 2 shows the relationship between the surface energies of the metals configuring the foundation layer and the (111) plane orientation index of the Cu layer in the case of forming the Cu layer on the foundation layer. In a sample, a foundation layer composed of Al, Ag—Pd—Cu, Cu, Ni—Cr and Ti is formed on a substrate, and a Cu layer is formed on the foundation layer. The thickness of the foundation layer is 10 nm, the thickness of the Cu layer is 50 nm to 60 nm, and the layers are formed by a sputtering method.

The (111) plane orientation index is an orientation index F by the Lotgering method. The maximum value of the orientation index by the Lotgering method is 1. An orientation index of 1 indicates complete orientation, and an orientation index of 0 indicates random orientation. The orientation index F is obtained from the following equation using the intensity of an X-ray diffraction peak that is obtained by the X-ray diffraction measurement of a layer (film) that should be evaluated.

$$F = ( ρ - {ρ}_{0} ) / ( 1 - {ρ}_{0} ) \\ {ρ}_{0} = Σ {I}_{0} ( 111 ) / Σ {I}_{0} ( hkl ) \\ ρ = Σ I ( 111 ) / Σ I ( hkl )$$

I₀(111) indicates the intensity of the X-ray diffraction peak of the (111) plane obtained by the X-ray diffraction measurement of an unoriented Cu powder. I₀(hkl) indicates the intensities of all diffraction peaks obtained by the X-ray diffraction measurement of an unoriented Cu film. In addition, the unoriented Cu film means a Cu film having an intensity pattern of X-ray diffraction peaks that is similar to the intensity pattern of X-ray diffraction peaks in a standard sample of copper that is described in Joint Committee on Powder Diffraction Standards (JCPDS).

I(111) indicates the intensity of the X-ray diffraction peak of the (111) plane obtained by the X-ray diffraction measurement of a layer (film) that should be evaluated. I(hkl) indicates the intensities of all diffraction peaks obtained by the X-ray diffraction measurement of a layer (film) that should be evaluated.

As the surface energies of the metals, actual measurement values described in Non Patent Literature L. Vitos, A. V. Ruban, H. L. Skriver and J. Kollar, “The surface energy of metals”, Surface Science, Elsevier, 1998, Vol. 411, Pages 186 to 202 were used. The values in the publication of the surface energies of a variety of metals are shown in Table 1. Regarding the alloys, the surface energies were calculated from the values in Table 1 based on the content fractions. The surface energies of metals are difficult to measure accurately, and the values in the publication of the surface energies of the metals have a margin of approximately 10%. The values shown in Table 1 are examples of the surface energies of metals.

As shown in FIG. 2, the (111) plane orientation index of the Cu layer that is formed on the foundation layer differs with the kind of the metal in the foundation layer, and it is considered that the surface energies of the metals that configure the foundation layer and the (111) plane orientation index of the Cu layer correlate with each other. As the surface energy of the metal that configures the foundation layer becomes higher, the (111) plane orientation index of the Cu layer also becomes large.

Incidentally, it is known that the surface energy of a metal has a plane orientation dependence, and, in metals having an FCC structure, the surface energy has a correlation of (110)>(100)>(111).

These facts show that, in a case where the surface energy of the metal in the first intermediate layer 31 is larger than the surface energy of the metal in the conductive layer 20, the formation of the conductive layer 20 on the first intermediate layer 31 converts the state to be energetically advantageous, and it is thus considered that the metal atoms in the first intermediate layer 31 are selectively arranged from a state where the first intermediate layer 31 is exposed to a state where the energy difference is largest, that is, the (111) plane of the conductive layer 20 is formed.

From FIG. 2, it is expected that, in a case where the conductive layer 20 includes Cu as a main component, when the surface energy of the first intermediate layer 31 is 1.5 J/m² or higher, the conductive layer 20 exhibits a (111) plane orientation index of approximately 0.7 or more.

TABLE 1

| | Surface energy | | Surface energy |
|---|---|---|---|
| Element | (J/m²) | Element | (J/m²) |
| W | 3.7 | Cr | 2.3 |
| Re | 3.6 | Hf | 2.2 |
| Os | 3.5 | Ti | 2.1 |
| Ta | 3.2 | Pd | 2.1 |
| Ru | 3.1 | Zr | 2.0 |
| Ir | 3.0 | Cu | 1.8 |
| Mo | 3.0 | Mn | 1.6 |
| Nb | 2.7 | Au | 1.5 |
| Rh | 2.7 | Sc | 1.3 |
| Co | 2.6 | Ag | 1.3 |
| V | 2.6 | Al | 1.2 |
| Fe | 2.5 | Y | 1.1 |
| Pt | 2.5 | Zn | 0.99 |
| Ni | 2.5 | Cd | 0.76 |

According to such a current collector of the present embodiment, the first intermediate layer 31 includes a metal as a main component, and the surface energy of the metal that is included in the first intermediate layer 31 is larger than the surface energy of the metal that is included in the conductive layer 20 as a main component, whereby the conductive layer 20 having a high (111) orientation is likely to be formed. Therefore, the conductive layer 20 has high corrosion resistance to a decomposition product of an electrolyte in lithium-ion secondary batteries and the like.

### Second Embodiment

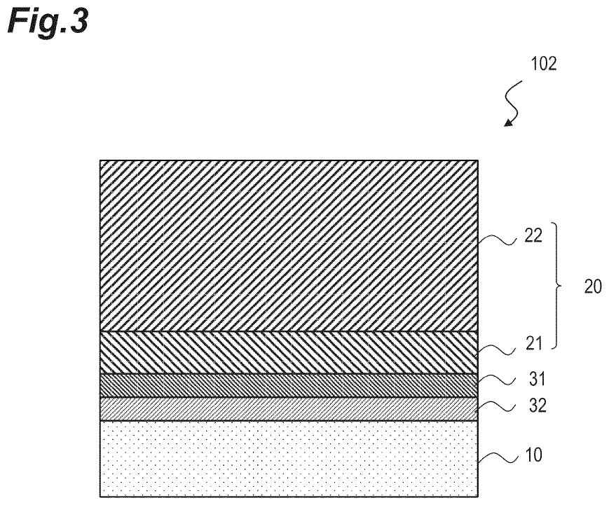

FIG. 3 is a schematic cross-sectional view showing one example of a current collector of the present embodiment. A current collector 102 of the present embodiment includes a resin layer 10, a conductive layer 20, a first intermediate layer 31 and a second intermediate layer 32. The first intermediate layer 31 is positioned between the resin layer 10 and the conductive layer 20. The second intermediate layer 32 is positioned between the first intermediate layer 31 and the resin layer 10. Furthermore, the current collector 102 is different from the current collector 101 of the first embodiment in terms of the fact that the second intermediate layer 32 is provided. The materials and thicknesses of the resin layer 10, the conductive layer 20 and the first intermediate layer 31, the functions of these layers and the like are as described in the first embodiment.

The second intermediate layer 32 enhances adhesion between the resin layer 10 and a layer that is formed on the resin layer 10. The second intermediate layer 32 includes a metal oxide as a main component in order for that. The second intermediate layer 32 may be in contact with the resin layer 10. The second intermediate layer 32 includes a metal oxide as a main component, whereby the adhesion to the resin layer 10 can be enhanced compared with a case where the conductive layer 20 or the first intermediate layer 31 that includes a metal as a main component is in contact with the resin layer 10.

A thickness D2 of the second intermediate layer 32 is, for example, 0.5 nm or more and 20 nm or less. When the thickness D2 of the second intermediate layer 32 is 0.5 nm or more, the continuous second intermediate layer 32 is formed, and it is easy to obtain an adhesion improvement effect. When the thickness of the second intermediate layer 32 is 20 nm or less, it is possible to shorten the time necessary to form the second intermediate layer 32, and deterioration of the resin layer 10 can be suppressed by decreasing the influence of damage attributed to conditions during the formation of the second intermediate layer 32, for example, heat or plasma on the resin layer 10. The thickness of the second intermediate layer 32 may be 1 nm or more or may be 2 nm or more. In addition, the thickness of the second intermediate layer 32 may be 10 nm or less.

The thickness D1 of the first intermediate layer 31 and the thickness D2 of the second intermediate layer 32 may satisfy a relationship of D1/D2≤10. When D1/D2≤10 is satisfied, it is considered that deterioration of the adhesion between the second intermediate layer 32 and the resin layer 10 caused by the first intermediate layer 31 becoming too thick and a large stress being applied to the second intermediate layer 32 is suppressed. D1/D2 may satisfy a relationship of 2≤D1/D2≤10.

The second intermediate layer 32 may include an oxide of at least one metal selected from the group consisting of Ni, Cr, Co, Ti, Zr, Nb, Hf, Ta and W. These metal oxides are passivated and are less likely to be oxidized up to the inside. That is, the second intermediate layer 32 itself is poorly soluble in a decomposition product of an electrolyte in a non-aqueous electrolytic solution. Therefore, dissolution of the second intermediate layer 32 in the interface with the resin layer 10 or the like is suppressed, and high adhesion can be maintained for a long period of time. The second intermediate layer 32 can be formed by, for example, a sputtering method in which a metal oxide is used as a target or a sputtering method in which a metal is used as a target and which is performed under an oxygen-including atmosphere.

The proportion of oxygen in the metal oxide that is included in the second intermediate layer 32 may be 0.3 or more to 1 of the metal element in terms of the mole ratio. That is, the metal oxide may be represented by the following composition formula.

MOx (x≥0.3)

Here, M is at least one selected from the group consisting of Ni,

Cr, Co, Ti, Zr, Nb, Hf, Ta and W.

When x is 0.3 or more, the second intermediate layer 32 becomes polar, and an intermolecular force is likely to work between the second intermediate layer and the resin layer 10, whereby the adhesion is enhanced. x is not limited to an integer. The upper limit of x depends on the largest valence that the metal can have in a stable oxidation state.

The second intermediate layer 32 may further include a metal carbide. When the second intermediate layer includes a carbide of at least one metal selected from the group consisting of Ni, Cr, Co, Ti, Zr, Nb, Hf, Ta and W, it is possible to further enhance the adhesion to the resin layer 10.

In addition, the element that configures the metal oxide that is included in the second intermediate layer 32 may be the same element as the metal that is included in the first intermediate layer 31. In this case, it is possible to continuously form the second intermediate layer 32 and the first intermediate layer 31 by, for example, a sputtering method in which the same metal target is used, and the adhesion between the second intermediate layer 32 and the first intermediate layer 31 can also be enhanced.

According to the current collector 102 of the present embodiment, the second intermediate layer 32 including a metal oxide is provided, whereby the adhesion between the conductive layer and the resin layer can be enhanced more than a case where the conductive layer and the resin layer are in direct contact with each other. In addition, the first intermediate layer 31 including a metal is included, whereby, unlike the case of the second intermediate layer 32 alone, the conductive layer 20 is in contact with the first intermediate layer 31 including not a metal oxide but a metal as a main component. Therefore, it is possible to enhance the crystallinity of the conductive layer 20 at the time of forming the conductive layer 20 and to enhance the corrosion resistance of the conductive layer 20 to a decomposition product of an electrolyte in a non-aqueous electrolytic solution.

In addition, the surface energy of the metal that is included in the first intermediate layer 31 is larger than the surface energy of the metal that is included as a main component in the conductive layer 20, whereby the (111) orientation of the conductive layer 20 is enhanced. Therefore, the conductive layer 20 has high corrosion resistance to a decomposition product of an electrolyte that can be generated in non-aqueous electrolytic solutions in lithium-ion secondary batteries and the like.

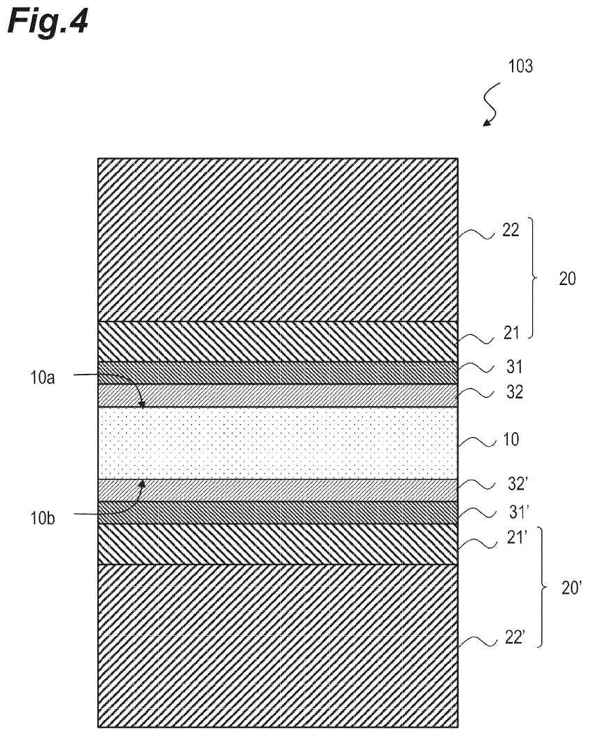

The current collector 102 described with reference to FIG. 3 includes the conductive layer 20 only on a single surface of the resin layer 10, but the conductive layers 20 may be provided on both surfaces. FIG. 4 shows a current collector 103 including conductive layers on both surfaces of a resin layer. The current collector 103 includes a resin layer 10 having a first surface 10a and a second surface 10b that is positioned on the opposite side to the first surface 10a. On the first surface 10a of the resin layer 10, the same structure as the above-described current collector 102 is formed.

Incidentally, on the second surface 10b of the resin layer 10 as well, the same structure as the current collector 102 is formed. Specifically, the current collector 103 further includes a conductive layer 20′, a first intermediate layer 31′ and a second intermediate layer 32′. The first intermediate layer 31′ is positioned between the resin layer 10 and the conductive layer 20′. The second intermediate layer 32′ is positioned between the first intermediate layer 31′ and the resin layer 10. The configuration materials and thicknesses of the conductive layer 20′, the first intermediate layer 31′ and the second intermediate layer 32′, the functions of these layers and the like are the same as the corresponding conductive layer 20, first intermediate layer 31 and second intermediate layer 32. From the viewpoint of stress, the configuration materials and thicknesses of the conductive layer 20′, the first intermediate layer 31′ and the second intermediate layer 32′ may be the same as the configuration materials and thicknesses of the corresponding conductive layer 20, first intermediate layer 31 and second intermediate layer 32.

According to the current collector 103, since the conductive layers 20 and 20′ are provided on both surfaces of the resin layer 10, it is possible to form electrodes on both surfaces. Therefore, it is possible to increase the battery capacity per unit area by decreasing the proportion of the resin layer in an electric storage device.

### Third Embodiment

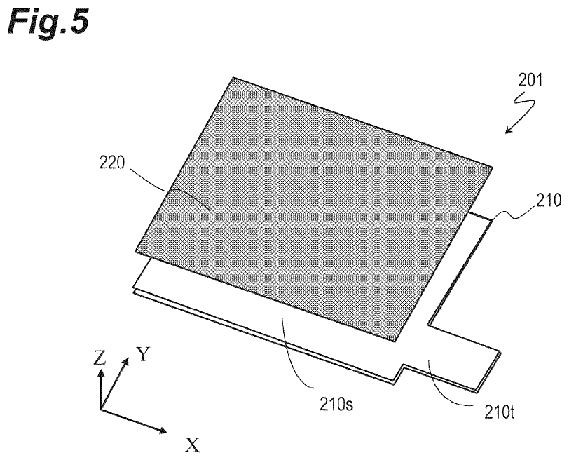

An embodiment of an electrode for an electric storage device will be described. The electrode for an electric storage device of the present embodiment can be used as a positive electrode or a negative electrode of an electric storage device. FIG. 5 is an exploded perspective view of an electrode for an electric storage device 201. The electrode for an electric storage device 201 includes a current collector 210 and an active material layer 220. The current collector 210 includes a first portion 210s and a second portion 210t, and the active material layer 220 is disposed on the first portion 210s. The second portion 210t is not provided with the active material layer 220 and functions as a tab for electric connection with the outside. The active material layer 220 includes an active material that is oxidized and reduced in association with charging (or electric storage) and discharging. The current collector 210 supports the active material layer 220, supplies electrons to the active material layer 220 and accepts electrons from the active material layer 220.

The current collector 210 is the current collector 101, 102 or 103 described in the first embodiment or the second embodiment. In the case of using the current collector 103, another active material layer that is not shown in FIG. 5 is disposed on the first portion 210s on the rear surface side (a side on which the active material layer 220 is not disposed) of the current collector 210.

The active material layer 220 includes a positive electrode active material or a negative electrode active material that absorbs and releases lithium ions. The positive electrode active material includes, for example, a lithium-including composite metal oxide. Examples of the lithium-including composite metal oxide include lithium cobalt oxide (LiCoO₂), lithium nickel oxide (LiNiO₂), lithium manganese oxide (LiMnO₂), lithium manganese spinel (LiMn₂O₄), lithium vanadium compound (LiV₂O₅), olivine-type LiMPO₄ (here, M is one or more elements selected from the group consisting of Co, Ni, Mn, Fe, Mg, Nb, Ti, Al and Zr or a vanadium oxide), lithium titanium oxide (Li₄Ti₅O₁₂), composite metal oxides represented by a general formula: LiNiₓCo_{y}Mn_{z}MₐO₂ (x+y+z+a=1, 0≤x<1, 0≤y<1, 0≤z<1, 0≤a<1, M in the general formula is one or more elements selected from the group consisting of Al, Mg, Nb, Ti, Cu, Zn and Cr), composite metal oxides represented by a general formula: LiNiₓCo_{y}Al_{z}O₂ (0.9<x+y+z<1.1) and the like. The positive electrode active material may include polyacetylene, polyaniline, polypyrrole, polythiophene, polyacene or the like as a material capable of absorbing and releasing lithium ions.

The active material layer 220 may further include at least one of a binder and an auxiliary conductive agent. As the binder, a variety of well-known materials can be used. As the binder in the active material layer 220 that is used in the positive electrode, fluororesins such as polyvinylidene fluoride (PVDF), polytetrafluoroethylene (PTFE), a tetrafluoroethylene-hexafluoropropylene copolymer (FEP), a tetrafluoroethylene-perfluoroalkyl vinyl ether copolymer (PFA), an ethylene-tetrafluoroethylene copolymer (ETFE), polychlorotrifluoroethylene (PCTFE), ethylene-chlorotrifluoroethylene copolymer (ECTFE) and polyvinyl fluoride (PVF) can be used.

As the binder, a vinylidene fluoride-based fluororubber may be used. For example, vinylidene fluoride-hexafluoropropylene-based fluororubber (VDF-HFP-based fluororubber), vinylidene fluoride-hexafluoropropylene-tetrafluoroethylene-based fluororubber (VDF-HFP-TFE-based fluororubber), vinylidene fluoride-pentafluoropropylene-based fluororubber (VDF-PFP-based fluororubber), vinylidene fluoride-pentafluoropropylene-tetrafluoroethylene-based fluororubber (VDF-PFP-TFE-based fluororubber), vinylidene fluoride-perfluoromethyl vinyl ether-tetrafluoroethylene-based fluororubber (VDF-PFMVE-TFE-based fluororubber), vinylidene fluoride-chlorotrifluoroethylene-based fluororubber (VDF-CTFE-based fluororubber) and the like may be applied as the binder in the active material 220 that is used in the positive electrode.

Examples of the auxiliary conductive agent are carbon materials such as a carbon powder and a carbon nanotube. Carbon black or the like may be applied as the carbon powder. Other examples of the auxiliary conductive agent in the active material layer 220 that is used in the positive electrode are the metal powders of nickel, stainless steel, iron and the like and the powders of conductive oxides such as ITO. Two or more of the above-described materials may be mixed together and included in the active material layer 220.

The negative electrode active material includes a carbon material. Examples of the carbon material include natural or artificial graphite, carbon nanotubes, non-graphitizable carbon, easily graphitizable carbon (soft carbon), low-temperature fired carbon and the like. The negative electrode active material may include a material other than the carbon material. For example, the particles of an alkali metal such as metallic lithium, an alkaline earth metal, a metal such as tin that is capable of forming a compound with a metal such as lithium, silicon, a silicon-carbon composite material, an amorphous compound mainly composed of an oxide (SiOₓ (0<x<2), tin dioxide or the like) or lithium titanate (Li₄Ti₅O₁₂) or the like may be included.

As the binder and the auxiliary conductive agent in the active material layer 220 that is used in the negative electrode, the above-described binder and auxiliary conductive agent can be used in the same manner. In addition, as the binder for the negative electrode, cellulose, styrene/butadiene rubber, ethylene/propylene rubber, polyimide, polyamide imide, an acrylic resin or the like may be used.

The electrode for an electric storage device that is used as the positive electrode and the negative electrode can be manufactured by a well-known manufacturing method.

The electrode for an electric storage device of the present embodiment has high corrosion resistance to a decomposition product of an electrolyte in non-aqueous electrolytic solutions. Therefore, even in a case where a lithium-ion secondary battery including the electrode for an electric storage device of the present embodiment is used under a condition where an electrolyte easily decomposes, for example, at a high temperature, deterioration of battery characteristics due to the deterioration of the current collector is suppressed.

### Fourth Embodiment

An embodiment of a lithium-ion secondary battery will be described.

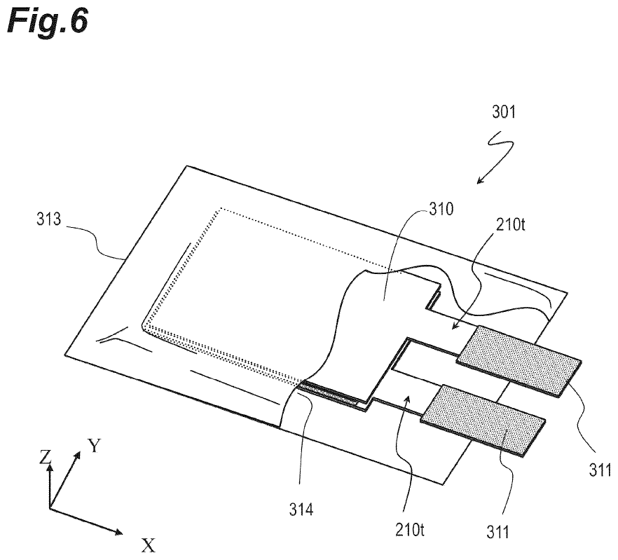

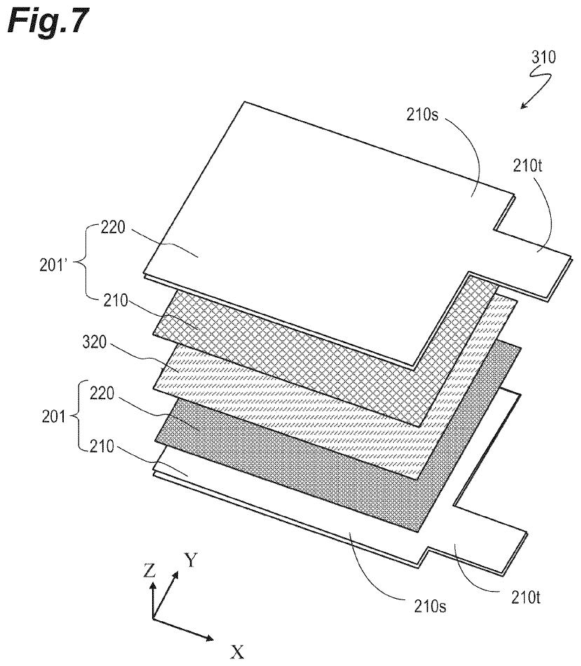

FIG. 6 is a schematic external view showing one example of a lithium-ion secondary battery 301, and FIG. 7 is an exploded perspective view showing a cell taken out from the lithium-ion secondary battery shown in FIG. 6. Here, as the lithium-ion secondary battery, a lithium-ion secondary battery that is referred to as a pouch type or a laminate type will be exemplified. The lithium-ion secondary battery shown in the drawings is a single-layer type, but may be a stacked type. In the example shown in the drawings, a positive electrode, a separator and a negative electrode that configure the cell are stacked along a Z direction in the drawings.

The lithium-ion secondary battery 301 includes a cell 310, a pair of leads 311 connected to the cell 310, an exterior body 313 that covers the cell 310 and an electrolyte 314.

The cell 310 includes an electrode for an electric storage device 201, an electrode for an electric storage device 201′ and a separator 320 disposed between these electrodes. In the example shown in the drawings, the cell 310 is a single-layer cell including a pair of electrodes.

The electrode for an electric storage device 201 and the electrode for an electric storage device 201′ are the electrode for an electric storage device 201 described in the third embodiment, one is configured as a positive electrode including a positive electrode active material, and the other is configured as a negative electrode including a negative electrode active material.

The separator 320 is an insulating porous material. For example, a single-layer film or stacked film of a polyolefin such as polyethylene or polypropylene, a non-woven fabric of at least one kind of fiber selected from the group consisting of cellulose, polyester, polyacrylonitrile, polyimide, polyamide (for example, aromatic polyamide), polyethylene and polypropylene, a porous film or the like can be used.

The electrolyte 314 is further disposed in the inside space of the exterior body 313. The electrolyte 314 is a non-aqueous electrolyte including a lithium ion and is, for example, a non-aqueous electrolytic solution including a lithium ion. In a case where a non-aqueous electrolytic solution is applied as the electrolyte 314, typically, a sealing material (for example, a resin film of polypropylene or the like, not shown in FIG. 6) for preventing the leakage of the non-aqueous electrolytic solution is disposed between the exterior body 313 and the lead 311.

As the electrolyte 314, for example, a non-aqueous electrolytic solution including a metal salt such as a lithium salt and an organic solvent can be used. As the lithium salt, for example, LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB or the like can be used. One of these lithium salts may be used singly or two or more thereof may be mixed together.

As the solvent in the electrolyte 314, for example, a cyclic carbonate and a chain carbonate can be used. Specifically, ethylene carbonate, propylene carbonate, butylene carbonate, dimethyl carbonate or the like can be used.

The lithium-ion secondary battery 301 can be manufactured by, for example, the following method. First, the electrodes 201 and 201′ are produced as described in the above-described embodiment. After that, the electrode 201 and the electrode 201′ are held such that the active material layers face each other across the separator 320 and inserted into the space of the exterior body 313. The electrolyte 314 is disposed in the space of the exterior body 313, and the exterior body 313 is sealed, whereby the lithium-ion secondary battery 301 is completed.

The lithium-ion secondary battery 301 has a high corrosion resistance to a decomposition product of an electrolyte in non-aqueous electrolytic solutions. Therefore, even in a case where the lithium-ion secondary battery is used at a high temperature, deterioration of battery characteristics due to the deterioration of the current collector is suppressed.

### EXAMPLES

Current collectors of examples and current collectors of reference examples were produced, and the characteristics were evaluated.

### Production of Samples

Current collectors of Example 1 to Example 24 and Reference Example 1 to Reference Example 4 were produced by the following method.

A current collector 102 having a structure shown in FIG. 3 was produced. For a resin layer 10, a 5 μm-thick polyethylene terephthalate resin was used. A first intermediate layer 31 and a second intermediate layer 32 were formed by a sputtering method in which a metal or a metal oxide shown in Table 3 to Table 6 was used as a target. The thicknesses of the first intermediate layer 31 and the second intermediate layer 32 were adjusted with the deposition time and the output. As a Cu conductive layer 20, a seed layer 21 and a main layer 22 were separately formed. The 50 nm-thick seed layer 21 was formed, and the main layer 22 having a thickness shown in Table 3 to Table 6 was formed by electrolytic plating. Al and Cu—Ni conductive layers were formed by a sputtering method in thicknesses shown in Table 3 to Table 6.

In Example 14 to Example 20 and Examples 21 and 23, regarding the second intermediate layers, the ratios between a metal and oxygen were controlled to become 1:1 in terms of the mole ratio. Regarding Examples 22 and 24, a metal carbide was further used as a target. The composition ratios in metal oxides were confirmed by composition analysis by X-ray photoelectron spectroscopy (XPS).

As shown in Table 3, the current collectors of Reference Example 1 to Reference Example 4 were produced without forming at least one of the first intermediate layer and the second intermediate layer.

### Evaluation

The (111) plane orientation index of the conductive layer was measured by an X-ray diffraction method and obtained with an orientation index F by the above-described Lotgering method. A device used for the measurement and measurement conditions are as described below.
Device name: PANalytical XPert PRO
Radiation source: CuKα ray
Accelerating voltage: 40 kV
Current: 45 mA
Scanning speed: 6 deg./min.
Sampling width: 0.02 deg.
Measurement method: Out of plane

The current collectors of Example 1 to Example 24 and Reference Example 1 to Reference Example 4 were held in an environment similar to that for lithium-ion secondary batteries, and peeling of the conductive layer and the corrosion of the conductive layer were evaluated. Specifically, an electrolytic solution of dimethyl carbonate including LiPF₆ at a concentration of 1 mol % was produced. Furthermore, water was added to the electrolytic solution in a proportion of 1000 ppm by mass to produce an electrolytic solution 1. Similarly, an electrolytic solution 2 for which the amount of water added was prepared to a proportion of 3000 ppm by mass and an electrolytic solution 3 for which the amount of water added was prepared to a proportion of 5000 ppm by mass were produced.

Any of the electrolytic solutions 1 to 3 was put into a includeer, the produced current collector was immersed in the electrolytic solution in the includeer, and the entire includeer was sealed with a laminate film and stored in a constant-temperature bath at 85° C. for 72 hours. After that, the current collector was taken out from the laminate film and washed with an organic solvent.

Regarding the current collector obtained after being stored at a high temperature, corrosion resistance and peeling resistance were evaluated. For the corrosion resistance, the surface resistance of the conductive layer was measured, and observation with an optical microscope was performed. The surface resistance of the conductive layer was measured with a low resistivity meter (trade name: LORESTA-GX MCP-T700, manufactured by Nittoseiko Analytech Co., Ltd.). In addition, the observation with an optical microscope was performed at a magnification of 100 to 200 times, arbitrary three observation regions were selected, and whether or not a hole was formed in the selected region was determined. In a case where the value of the surface resistance of the conductive layer increased by 20% or more compared with that before the storage at a high temperature or a hole in the conductive layer was found by the observation, the surface resistance was determined as POOR, and, in a case where the increase in the resistance value was less than 20% and no holes were found in the conductive layer, the surface resistance was determined as GOOD.

The peeling resistance was evaluated by two methods. The surface of the conductive layer in the current collector after being stored at a high temperature was rubbed with a cotton swab, in a case where a part of the conductive layer was attached to the cotton swab, the conductive layer was admitted to peel off from the resin layer, and the peeling resistance was determined as POOR. In addition, pressure-sensitive adhesive tape having an adhesive force of 4 N/cm was pasted to the surface of the conductive layer in the current collector after being stored at a high temperature, and whether or not the conductive layer was attached thereto was investigated. In a case where peeling by the cotton swab was admitted, but adhesion by the pressure-sensitive adhesive tape was not admitted, the peeling resistance was determined as GOOD. In a case where peeling by the cotton swab was not admitted and adhesion by the pressure-sensitive adhesive tape was also not admitted, the peeling resistance was determined as EXCELLENT.

The produced current collectors, the electrolytic solutions used for the storage and the evaluations performed are summarized in Table 2. The evaluation results are shown in Table 3 to Table 6.

TABLE 2

| Evaluation | Storage electrolytic | | |
|---|---|---|---|
| object | solution | Evaluation item | Result |
| Examples | Electrolytic | Peeling resistance test | Table 3 |
| 1 to 6, | solution 1 | | |
| Reference | | | |
| Examples | | | |
| 1 to 4 | | | |
| Examples | Electrolytic | (111) plane orientation index, | Table 4 |
| 7 to 13 | solution 2 | peeling resistance test, | |
| | | corrosion resistance test | |
| Examples | Electrolytic | (111) plane orientation index, | Table 5 |
| 14 to 20 | solution 3 | corrosion resistance test | |
| Examples | Electrolytic | Peeling resistance test | Table 6 |
| 21 to 24 | solution 2 | | |

### Results and Consideration

As shown in Table 3, the results of the peeling resistance test were POOR in all of the current collectors of Reference Examples 1 to 4 where the second intermediate layer was not provided, but the results of GOOD or EXCELLENT were obtained in the current collectors of Examples 1 to 6. The current collectors of Reference Examples 2 and 4 included the first intermediate layer, but the layer included no metal oxides, and it is thus considered that the peeling resistance improvement effect was small. It is found that, when the thickness of the second intermediate layer is 0.5 nm or more and 20 nm or less, favorable peeling resistance can be obtained. Particularly, when the thickness of the second intermediate layer is 2 nm or more and 10 nm or less, excellent peeling resistance can be obtained.

TABLE 3

| | Conductive | First intermediate | Second intermediate | | Peeling resistance |
|---|---|---|---|---|---|
| | layer | layer: D1 | layer: D2 | D1/D2 | test 1 |
| Example 1 | Cu: 0.8 um | Ni: 20 nm | Ni—O: 0.5 nm | 40 | GOOD |
| Example 2 | Cu: 0.8 um | Ni: 20 nm | Ni—O: 1 nm | 20 | GOOD |
| Example 3 | Cu: 0.8 um | Ni: 20 nm | Ni—O: 2 nm | 10 | EXCELLENT |
| Example 4 | Cu: 0.8 um | Ni: 20 nm | Ni—O: 10 nm | 2 | EXCELLENT |
| Example 5 | Cu: 0.8 um | Ni: 20 nm | Ni—O: 20 nm | 1 | GOOD |
| Reference Example 1 | Cu: 0.8 um | N/A | N/A | — | POOR |
| Reference Example 2 | Cu: 0.8 um | Ni: 20 nm | N/A | — | POOR |
| Example 6 | Al: 0.8 um | Ni: 20 nm | Ni—O: 10 nm | 2 | EXCELLENT |
| Reference Example 3 | Al: 0.8 um | N/A | N/A | — | POOR |
| Reference Example 4 | Al: 0.8 um | Ni: 20 nm | N/A | — | POOR |

As shown in Table 4, it is found that, when the thickness of the first intermediate layer is 1 nm or more and 120 nm or less, the conductive layer is capable of obtaining favorable corrosion resistance and peeling resistance. Particularly, it is found that, when the thickness of the first intermediate layer is 2 nm or more and 100 nm or less, the conductive layer has excellent corrosion resistance and peeling resistance. In addition, from Table 3 and Table 4, it is found that, when D1/D2, which is the ratio of the first intermediate layer to the second intermediate layer, satisfies D1/D2≤10, a current collector that is excellent in terms of both peeling resistance and corrosion resistance is obtained. Furthermore, it is found that, when D1/D2 satisfies 2≤D1/D2≤10, the current collector is superior in terms of peeling resistance and corrosion resistance.

TABLE 4

| | | (111) plane | First | Second | | Peeling | Corrosion |
|---|---|---|---|---|---|---|---|
| | Conductive | orientation index | intermediate | intermediate | | resistance | resistance |
| | layer | of conductive layer | layer D1 | layer D2 | D1/D2 | test 2 | test 2 |
| Example 7 | Cu: 0.8 um | 0.25 | Ni: 1 nm | Ni—O: 10 nm | 0.1 | EXCELLENT | GOOD |
| Example 8 | Cu: 0.8 um | 0.3 | Ni: 2 nm | Ni—O: 10 nm | 0.2 | EXCELLENT | EXCELLENT |
| Example 9 | Cu: 0.8 um | 0.45 | Ni: 20 nm | Ni—O: 10 nm | 2 | EXCELLENT | EXCELLENT |
| Example 10 | Cu: 0.8 um | 0.6 | Ni: 100 nm | Ni—O: 10 nm | 10 | EXCELLENT | EXCELLENT |
| Example 11 | Cu: 0.8 um | 0.6 | Ni: 120 nm | Ni—O: 10 nm | 12 | GOOD | EXCELLENT |
| Example 12 | Al: 0.8 um | 0.3 | Ni: 2 nm | Ni—O: 10 nm | 0.2 | EXCELLENT | EXCELLENT |
| Example 13 | Al: 0.8 um | 0.45 | Ni: 20 nm | Ni—O: 10 nm | 2 | EXCELLENT | EXCELLENT |

In Table 5, in the current collector of Example 16, the surface energy of Ag, which is the metal in the first intermediate layer, is smaller than the energy of Cu, which is the metal in the conductive layer (Table 1). In addition, in the current collectors other than Example 16, the surface energy of the metal in the first intermediate layer is larger than the energy of the metal in the conductive layer. The (111) plane orientation indexes were as small as 0.25 in the current collector of Example 16 and were large values of 0.65 or more in the current collectors of Example 14, Example 15 and Example 17 to Example 20, which are examples other than Example 16. This is considered to indicate that, as described above, the magnitude relationship between the first intermediate layer and the conductive layer in terms of the surface energy of the metal has an influence on easiness in the (111) plane orientation.

In addition, in the current collectors of Example 14, Example 15 and Example 17 to Example 20, the first intermediate layer is composed of a variety of metals such as Cr, Mo, Co, Ni—Cr and W, but the (111) plane orientation indexes become large in all of the current collectors. This is considered to indicate that the lattice constant in the crystal of the metal that configure the first intermediate layer or the crystallinity of the first intermediate layer has little influence on the (111) plane orientation index.

Furthermore, compared with the current collector of Example 16, in the current collectors of Example 14, Example 15 and Example 17 to Example 20, the corrosion resistance of the conductive layer is further enhanced. This is considered to indicate that the value of the (111) plane orientation index of the conductive layer and corrosion resistance correlate with each other.

From these facts, it is considered that, as described in detail in the first embodiment, when the surface energy of the metal that is included in the first intermediate layer is larger than the surface energy of the metal that is included in the conductive layer, the orientation of the (111) plane of the conductive layer is effectively enhanced, and corrosion resistance can be improved.

TABLE 5

| | | (111) plane | First | Second | Corrosion |
|---|---|---|---|---|---|
| | Conductive | orientation | intermediate | intermediate | resistance |
| | layer | index | layer D1 | layer D2 | test 3 |
| Example 14 | Cu: 0.8 um | 0.85 | Cr: 5 nm | Cr—O: 2 nm | EXCELLENT |
| Example 15 | Cu: 0.8 um | 0.9 | Co: 5 nm | Co—O: 2 nm | EXCELLENT |
| Example 16 | Cu: 0.8 um | 0.25 | Ag: 5 nm | Ag—O: 2 nm | GOOD |
| Example 17 | Cu: 0.8 um | 0.75 | Ni—Cr: 5 nm | Ni—Cr—O: 2 nm | EXCELLENT |
| Example 18 | Cu: 0.8 um | 0.75 | W: 5 nm | W—O: 2 nm | EXCELLENT |
| Example 19 | Al: 0.8 um | 0.9 | Cr: 5 nm | Cr—O: 2 nm | EXCELLENT |
| Example 20 | Ni: 0.8 um | 0.65 | Mo: 5 nm | Mo—O: 2 nm | EXCELLENT |

As shown in Table 6, it is found that, when the second intermediate layer further includes a metal carbide, the peeling resistance is further enhanced compared with a case where the second intermediate layer includes only the metal oxide.

TABLE 6

| | Conductive | First intermediate | Second intermediate | Corrosion |
|---|---|---|---|---|
| | layer | layer: D1 (5 nm) | layer: D2 (5 nm) | resistance test 4 |
| Example 21 | Cu: 0.8 um | Ni—Cr | Cr—O | GOOD |
| Example 22 | Cu: 0.8 um | Ni—Cr | Cr—O (80%), Cr—C (20%) | EXCELLENT |
| Example 23 | Cu: 0.8 um | W | W—O | GOOD |
| Example 24 | Cu: 0.8 um | W | W—O (80%), W—C (15%) | EXCELLENT |

From these examples and reference examples, it was found that the current collector of the present embodiment includes the first intermediate layer and the second intermediate layer, whereby it is possible to enhance corrosion resistance to a decomposition product of an electrolyte in non-aqueous electrolytic solutions and peeling resistance.

### INDUSTRIAL APPLICABILITY

The electrode for an electric storage device according to the embodiment of the present disclosure is useful as a power supply for a variety of electronic devices and electric motors. The electric storage device according to the embodiment of the present disclosure can be applied as, for example, as a power supply for vehicles represented by bicycles and cars, a power supply for communication devices represented by smartphones, a power supply for a variety of sensors and a power supply for unmanned extended vehicles (UxVs).

### REFERENCE SIGNS LIST

10, 10′ Resin layer
10a First surface
10b Second surface
20, 20′ Conductive layer
21 Seed layer
22 Main layer
31, 31′ First intermediate layer
32, 32′ Second intermediate layer
101, 102, 103 Current collector
201, 201′ Electrode for electric storage device
210 Current collector
210s First portion
210t Second portion
220 Active material layer
300 Exterior body
301 Lithium-ion secondary battery
310 Cell
311 Lead
313 Exterior body
314 Electrolyte
320 Separator

1. A current collector comprising:
a resin layer;
a conductive layer;
a first intermediate layer that is positioned between the resin layer and the conductive layer; and
a second intermediate layer that is positioned between the first intermediate layer and the resin layer,
wherein the first intermediate layer includes a metal as a main component, and
the second intermediate layer includes a metal oxide as a main component.

2. The current collector according to claim 1,
wherein a thickness D2 of the second intermediate layer satisfies 0.5 nm≤D2≤20 nm.

3. The current collector according to claim 1,
wherein a thickness D1 of the first intermediate layer satisfies 1 nm≤D1≤120 nm.

4. The current collector according to claim 1,
wherein the conductive layer includes a metal as a main component, and
a surface energy of the metal in the first intermediate layer is larger than a surface energy of the metal in the conductive layer.

5. The current collector according to claim 1,
wherein the first intermediate layer includes at least one metal selected from the group consisting of Ni, Cr, Co, Ti, Zr, Nb, Hf, Ta and W.

6. The current collector according to claim 1,
wherein the second intermediate layer includes an oxide of at least one metal selected from the group consisting of Ni, Cr, Co, Ti, Zr, Nb, Hf, Ta and W.

7. The current collector according to claim 1,
wherein the first intermediate layer and the second intermediate layer include the same metal.

8. The current collector according to claim 1,
wherein the second intermediate layer further includes a metal carbide.

9. The current collector according to claim 1,
wherein the conductive layer includes one metal selected from the group consisting of Al, Ag, Cu, Ni and a Ni—Cu alloy.

10. The current collector according to claim 1,
wherein an orientation index of a (111) plane of the conductive layer by a Lotgering method in a direction perpendicular to the resin layer is 0.3 or more.

11. The current collector according to claim 1,
wherein a thickness D3 of the conductive layer satisfies
0.3 μm≤D3≤2 μm.

12. The current collector according to claim 3,
wherein a thickness D2 of the second intermediate layer satisfies 0.5 nm≤D2≤20 nm, and
the thickness D1 of the first intermediate layer and the thickness D2 of the second intermediate layer satisfy
D1/D2≤10.

13. The current collector according to claim 1,
wherein the resin layer includes at least any one of polyethylene terephthalate, polypropylene, polyamide, polyimide, polyethylene, polystyrene, a phenolic resin and an epoxy resin.

14. An electrode for an electric storage device, comprising:
the current collector according to claim 1; and
an active material layer that is positioned on the conductive layer of the current collector.

15. A lithium-ion secondary battery comprising:
a positive electrode;
a negative electrode;
a separator that is disposed between the negative electrode and the positive electrode; and
a non-aqueous electrolyte including a lithium ion,
wherein at least one of the positive electrode or the negative electrode is the electrode for an electric storage device according to claim 14.
